(19) United States
(12) Patent Application Publication
(10) Pub. No.: US 2025/0155342 A1
(43) Pub. Date: May 15, 2025

(54) Shingle Damage Testing Apparatus and Method of Use

(71) Applicant: Reedpoint LLC, Jacksonville, FL (US)

(72) Inventor: Christian Reed, Jacksonville, FL (US)

(21) Appl. No.: 18/389,088

(22) Filed: Nov. 13, 2023

(51) Int. Cl. G01N 3/08; G01N 3/06

(52) U.S. Cl. CPC G01N 3/08; G01N 3/066; G01N 2203/0017

(57) ABSTRACT

The present disclosure provides an exemplary, non-limiting embodiment of a shingle damage testing apparatus and method of use. The exemplary, non-limiting embodiment of the shingle damage testing apparatus includes a variety of components which comprises a load distribution bar, a radial uplift gauge, and a lifting scale. The load distribution bar may be configured to couple to the lifting scale and a free edge of an asphalt shingle. The radial uplift gauge may be configured to attach to a free edge of a shingle directly adjacent to the asphalt shingle which is to be tested. The radial curvature of the radial uplift gauge allows for the user to accurately measure the arc length at the free edge of the shingle being tested while the free edge is subjected to a predetermined uplift force. The lifting scale allows the user to apply a precise and consistent uplift force during testing.

### FIELD OF THE INVENTION

This invention relates generally to quantifying damage of roof coverings and pertains specifically to an apparatus and in-situ method for non-destructively evaluating damage of asphalt roofing shingles.

### BACKGROUND

Accessing roof damage after a storm is predominantly reliant on qualitative observations. In the United States, as well as other countries, if a homeowner's roof is damaged during a storm, such as a hurricane or other act of nature, and the homeowner submits a property claim to his insurance provider, the insurance provider will schedule a claims adjuster to visit the property and perform an inspection of the property to determine the validity of the claim as well as the value of the cost to repair or replace the damaged property. Homeowners rely on claims adjusters to accurately assess the extent of property damage and offer fair compensation in accordance with the homeowner's insurance policy.

The inspection performed by a claims adjuster, engineer, or other technicians skilled in the art typically comprises visual observations, often without any standardized quantitative testing. A claims adjuster may elect to lift the free edge of one or more shingles to qualitatively assess damage to the roofing shingles. However, claims adjusters who perform inspections which do not comprise at least one testing protocol that quantifies damage using a systematic procedure diminish the standardization of their inspection and increase their risk of subjective interpretation, which ultimately jeopardizes the integrity of their inspection. Furthermore, it is crucial to recognize the inherent potential for cognitive biases to influence the inspection process. Claims adjusters frequently face demanding workloads and tight deadlines, leading to time constraints that can contribute to biases. These biases, whether overt or subconscious, can significantly skew outcomes and compromise the integrity of equitable claims settlement.

Accordingly, to increase standardization of the inspection process, mitigate potential biases of the claims adjusters, and improve objectivity of data collected by a claims adjuster during a property damage claims inspection, a shingle damage testing apparatus and method are disclosed herein.

### SUMMARY OF THE INVENTION

The present disclosure provides an exemplary, non-limiting embodiment of a shingle damage testing apparatus and method for non-destructively quantifying damage to asphalt roofing shingles installed on a roof. The shingle damage testing apparatus is designed to generate reliable, reproducible measurements that when used in combination with the corresponding method of use will yield objective, evidence-based conclusions.

The exemplary, non-limiting embodiment of the shingle damage testing apparatus comprises a variety of components that improve consistency of testing radial uplift of one or more asphalt shingles on the roof. The variety of components comprise a load distribution bar, a radial uplift gauge, and a lifting scale. The load distribution bar having a top edge and a bottom edge opposite from the top edge is constructed of a rigid material and comprises a plurality of pick points which further comprise a lifting pick point, a plurality of architectural shingle pick points, and a plurality of three-tab shingle pick points. The plurality of pick points are exemplified as a plurality of holes that bore laterally through the thickness of the load distribution bar. Preferably, the lifting pick point is adjacent to a middle portion of the top edge of the load distribution bar. The architectural shingle pick points and the three-tab shingle pick points are adjacent to the bottom edge of the load distribution bar and are preferably aligned on a same horizontal line paralleled to the bottom edge of the load distribution bar. Each of the four architectural shingle pick points is equally spaced to each other, and each of the three three-tab shingle pick points is equally spaced to each other. Therefore, uplift measurements are performed from a balanced position. However, it is anticipated that the plurality of pick points could alternatively comprise ancillary hooks, brackets, dowels, or other anchoring configurations suitable for attaching the lifting scale or plurality of couplers.

The lifting scale is configured to attach to the load distribution bar at the lifting pick point. The lifting scale allows for an individual to apply a consistent uplift force to the load distribution bar, which is mechanically coupled to the free edge of the shingle being tested. The lifting scale must be portable, but may be digital or mechanical.

The radial uplift gauge comprises a radial section and a flat section. The radial section is configured with graduated scale and extends vertically about a predetermined radius from the flat section. A clamp is pivotably attached to the flat section to allow the radial uplift gauge to conveniently attach to the free edge of an adjacent shingle so that the radial uplift of the shingle being tested may be accurately measured.

A plurality of couplers may be configured to attach to either the plurality of architectural shingle pick points or three-tab shingle pick points, depending on whether the roof is shingled with architectural shingles or three-tab shingles. The plurality couplers also may be configured to detachably couple to the shingle which is to be tested. It is imperative that each coupler of the plurality of couplers is pivotably attached to the load distribution bar to allow the free edge of the shingle being tested to follow a radial arc as it is lifted to prevent damage to the shingle during the uplift test.

An exemplary, non-limiting method of using the exemplary, non-limiting embodiment of the shingle damage testing apparatus includes a plurality of steps which allow for identification of a control and experimental group, each comprising a plurality of shingles and standardized experimental setup and measurement recordation. It is anticipated that several steps may be sequentially interchangeable and equivalent application of one or more permutations of such sequentially interchangeable steps does not alter the spirit of the invention in any meaningful way.

The plurality of steps for the exemplary, non-limiting method includes a first step of determining whether the roof is shingled with architectural or three-tab shingles and then attaching each coupler of the plurality of couplers to an architectural shingle pick point if the roof is shingled with architectural asphalt shingles or to a three-tab shingle pick point if the roof is shingled with three-tab asphalt shingles. The next step of the method is to identify at least two “undamaged shingles” which is known to be performing as intended, which will be dependent on the age and anticipated service life of the roof. The two or more undamaged shingles selected will serve as the control group.

The next step is to attach the radial uplift gauge to the free edge of a shingle located laterally adjacent to the undamaged shingle. The next step is to detachably couple the plurality of couplers to the free edge of the undamaged shingle. The next step is to attach the lifting scale to the lifting pick point, thereby mechanically coupling the lifting scale to the load distribution bar. The next step is to slowly lift the lifting scale along a substantially vertical path until a predetermined uplift force is imparted onto the free edge of the shingle being tested. The next step is to record the arc length of the radial uplift at the free edge of the shingle while under load by referencing the radial uplift gauge which is located directly adjacent to one of the two corners of the free edge.

The next step is to identify a random sample of two or more roofing shingles that will provide statistically significant results that allow for extrapolation to a section or the entirety of the roof. The random sample of roofing shingles will serve as the experimental group. The next step is to repeat steps three through seven for each shingle in the experimental group. The next and final step is to compare the radial uplift measurements of the control group with the experimental group and determine if there is a statistically significant difference between the uplift measurements that were collected during testing of each group.

### BRIEF DESCRIPTION OF THE DRAWINGS

FIG. 1 depicts a front elevation view of an exemplary, non-limiting embodiment of a load distribution bar comprising a lifting pick point, a plurality of three-tab shingle pick points, and a plurality of architectural shingle pick points, wherein a lifting scale is attached to the lifting pick point and each of the architectural shingle pick points is attached to a distinct coupler respectively.

FIG. 2 depicts a front and side view of an exemplary, non-limiting embodiment of a radial uplift gauge comprising a radial section, a flat section and a clamp pivotably attached to the flat section.

FIG. 3 depicts an enlarged side view of the exemplary, non-limiting embodiment of the radial uplift gauge further illustrating a predetermined radius of its radial section.

FIG. 4 depicts an in-use view of an individual utilizing an exemplary, non-limiting embodiment of a shingle damage testing apparatus on an asphalt shingle installed on a roof.

FIG. 5 depicts an enlarged partial view of the in-use view of the individual utilizing the exemplary, non-limiting embodiment of the shingle damage testing apparatus.

### NUMBER REFERENCES

5—Shingle Damage Testing Apparatus
10—Load Distribution Bar
11—Lifting Pick Point
15A—Architectural Shingle Pick Point
15B—Three-Tab Shingle Pick Point
20—Coupler
30—Radial Uplift Gauge
30A—Radial Section
30B—Flat Section
35—Clamp
40—Roof
45—Shingle
46—Adjacent Shingle
Lifting Scale

### DETAILED DESCRIPTION

In the following description, reference is made to the accompanying drawings which form a part hereof and which illustrate an embodiment of the present disclosure. It is understood that other embodiments may be utilized, and structural and operational changes may be made without departing from the scope of the present disclosure.

The present disclosure provides an exemplary, non-limiting embodiment of a shingle damage testing apparatus 5 and methods of using the shingle damage testing apparatus for nondestructive evaluation of existing damage to asphalt roofing shingles installed on a roof 40. The shingle damage testing apparatus 5 is designed to generate reliable, reproducible measurements.

The exemplary, non-limiting embodiment of the shingle damage testing apparatus 5 comprises a variety of components that improve consistency and accuracy of testing radial uplift along the free edge of one or more asphalt shingles 45 on the roof 40. The variety of components comprise a load distribution bar 10, a radial uplift gauge 30, and a lifting scale 50. The load distribution bar 10 having a top edge and a bottom edge opposite from the top edge is constructed of a rigid material, such as but not limited to a metal alloy or a fiber-reinforced composite, and comprises a plurality of pick points which further comprise a lifting pick point 11, a plurality of architectural shingle pick points 15A, and a plurality of three-tab shingle pick points 15B. The load distribution bar 10 preferably has a substantially solid rectangular cross-section and has a length that is approximately equal to the length of the asphalt shingles being tested. However, it is anticipated that the load distribution bar 10 could be formed such that its longitudinal cross-section is of an alternative shape such that its moment of inertia about its longitudinal axis is sufficiently stiff to substantially resist flexural displacement during application of the method of use as described herein.

As shown in FIG. 1, the plurality of pick points 11, 15A, 15B are exemplified as a plurality of holes that bore laterally through the thickness of the load distribution bar 10, including one lifting pick point 15A, four architectural shingle pick points 15A, and three three-tab shingle pick points 15b. Preferably, the lifting pick point 11 is located adjacent to a middle portion of the top edge of the load distribution bar 10. The architectural shingle pick points 15A and the three-tab shingle pick points 15B are preferably aligned on a same horizontal line paralleled to the length of the load distribution bar 10 and adjacent to the bottom edge thereof. Each of the four architectural shingle pick points 15A is equally spaced to each other, and each of the three three-tab shingle pick points 15B is equally spaced to each other. Therefore, uplift measurements are performed from a balanced position. However, it is anticipated that the location and number of the plurality of pick points 11, 15A, 15B could differ and may alternatively comprise ancillary hooks, brackets, dowels, or other anchoring configurations suitable for attaching the lifting scale 50 or a plurality of couplers 20.

The lifting scale 50 is configured to attach to the load distribution bar at the lifting pick point 11. The lifting scale 50 allows for an individual to apply a consistent uplift force to the load distribution bar 10, which is mechanically coupled to the free edge of the shingle 45 being tested. The lifting scale 50 must be portable, but may be digital or mechanical.

A plurality of couplers 20 may be configured to attach to either the plurality of architectural shingle pick points 15A or three-tab shingle pick points 15B, depending on whether the roof 40 is shingled with architectural shingles or three-tab shingles 45. The plurality couplers 20 also may be configured to detachably couple to the shingle 45 which is to be tested. It is imperative that the plurality of couplers 20 are pivotably attached to the load distribution bar 10 to allow the free edge of the shingle 45 being tested to follow a radial arc as it is lifted to prevent damage to the shingle 45 during the uplift test.

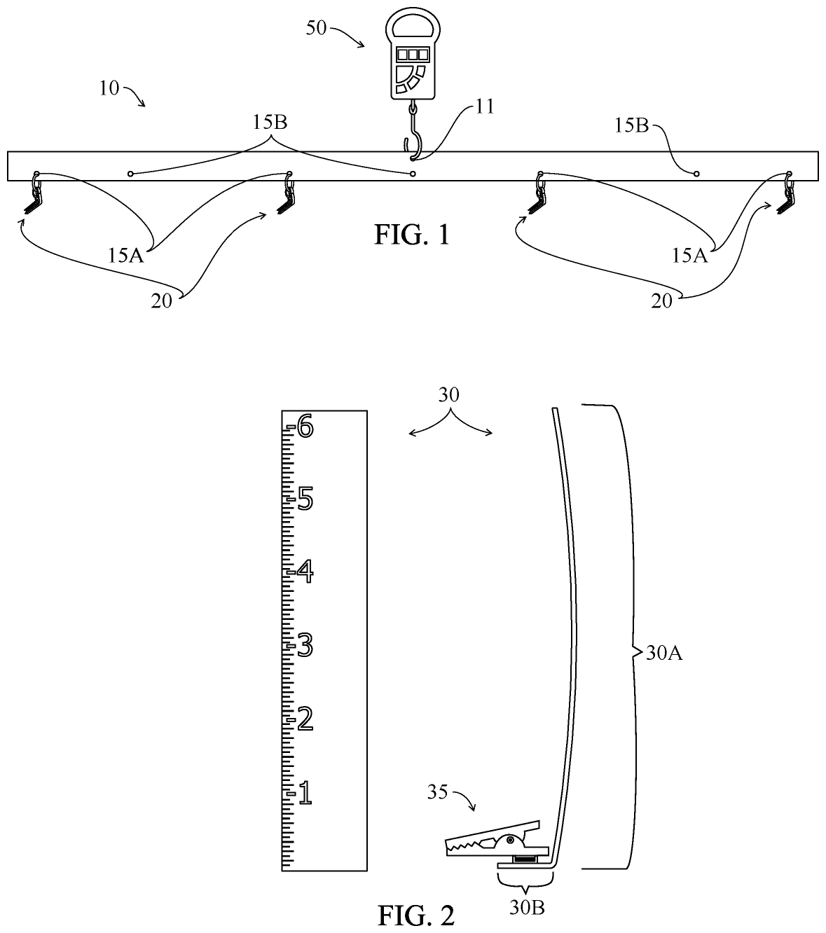

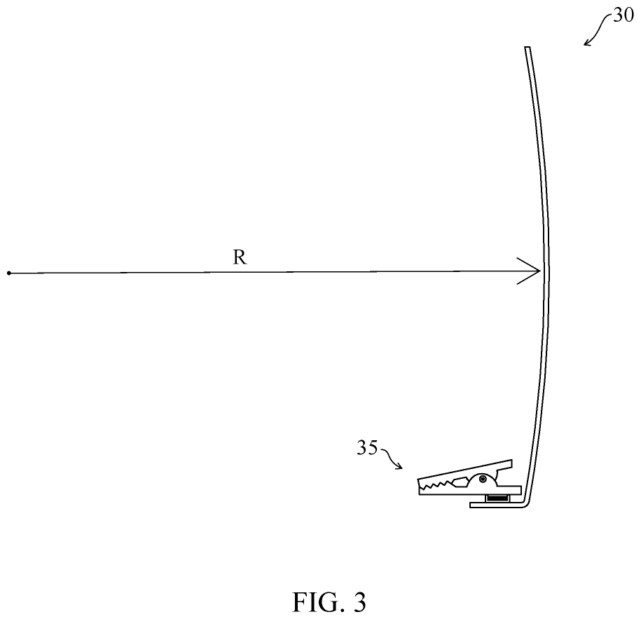

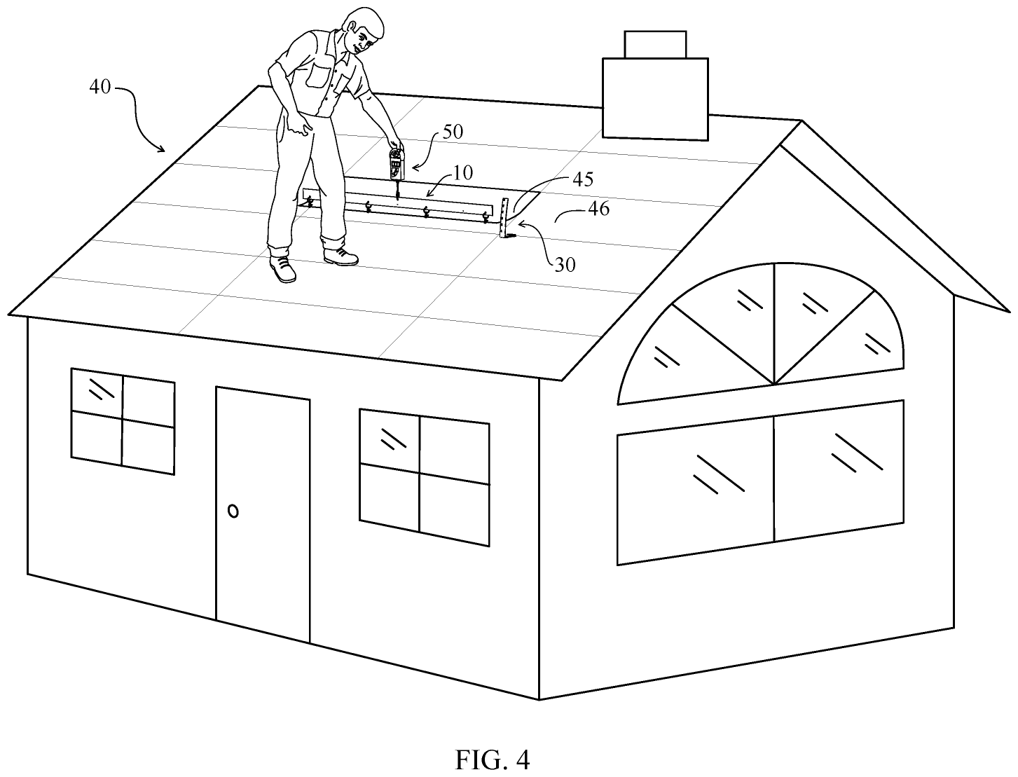

Referring to FIG. 2, the radial uplift gauge 30 comprises a radial section 30A and a flat section 30B. Preferably, the radial section 30A is generally rectangularly shaped having a curvature and having a side configured with a graduated scale. As shown in FIG. 3, the radial section 30A extends vertically about a predetermined radius R from the flat section 30B. The radius R may vary according to the width of the shingle 45. A clamp 35 having an opening facing away from the radial section 30A is pivotably attached to the flat section 30B to allow the radial uplift gauge 30 to conveniently attach to the free edge of an adjacent shingle 46 so that the radial uplift of the shingle being tested may be accurately measured. It is anticipated that the graduate scale can be in units of inches, centimeters or millimeters.

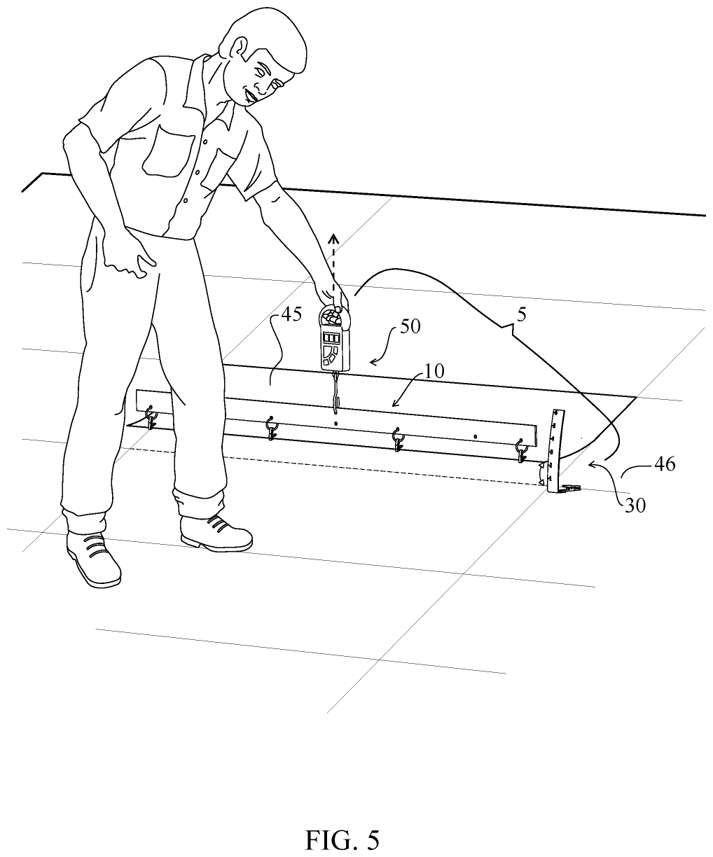

Referring to FIGS. 4-5, an exemplary, non-limiting method of using the exemplary, non-limiting embodiment of the shingle damage testing apparatus 5 includes a plurality of steps which allow for identification of a control and experimental group, each comprising a plurality of shingles 45 and standardized experimental setup and measurement recordation. It is anticipated that several steps may be sequentially interchangeable and equivalent application of one or more permutations of such sequentially interchangeable steps does not alter the spirit of the invention in any meaningful way.

The plurality of steps for the exemplary, non-limiting method includes firstly determining whether the roof 40 is shingled with architectural asphalt shingles or three-tab asphalt shingles 45; secondly attaching each coupler 20 of the plurality of couplers 20 to an architectural shingle pick point 15A if the roof 40 is shingled with architectural asphalt shingles 45 or to a three-tab shingle pick point 15B if the roof 40 is shingled with three-tab asphalt shingles 45; thirdly identifying at least two “undamaged shingles” 45 known to be performing as intended, which will serve as a control group; fourthly attaching the radial uplift gauge 30 to the free edge of a shingle 45 located laterally adjacent to the undamaged shingle 45; fifthly coupling the plurality of couplers 20 to the free edge of one of the undamaged shingle 45; sixthly attaching the lifting scale 50 to the lifting pick point 11; seventhly slowly lifting the lifting scale 50 along a substantially vertical path until a predetermined uplift force is imparted onto the free edge of the shingle 45 being tested; eighthly recording the arc length of the radial uplift at the free edge of the shingle 45 while under load by referencing the radial uplift gauge 30 which is located directly adjacent to one of the two corners of the free edge; ninthly repeating steps four through eight for the remaining undamaged shingles 45 selected in step three; tenthly identifying a random sample of two or more roofing shingles 45, which will serve as an experimental group, that contains enough shingles 45 to provide statistically significant results that allow for extrapolation to a section or the entirety of the roof 40; eleventhly repeating steps four through eight for each shingle 45 in the experimental group; twelfthly comparing the radial uplift measurements of the control group with the radial uplift measurements of the experimental group and determining if a statistically significant difference exists between the uplift measurements collected during testing of each group. Identifying the “undamaged shingles” 45 is well known in the art, which is typically determined by examining if any visual signs of damage exist. The visual signs may include but are not limited to curling or buckling at edges of the shingles 45, cracks, tears, or punctures of the shingles 45, granules on shingles 45 worn away, or seal between the shingles 45 exhibit indications of destruction.

In an alternative embodiment, steps one to six remain the same as the aforementioned embodiment. Thereafter, seventhly slowly lifting the lifting scale 50 along a substantially vertical path and referencing the radial uplift gauge 30 which is located directly adjacent to one of the two corners of the free edge until the free edge of the shingle 45 reaches a predetermined arch length; eighthly recording a uplift force measured by the lifting scale 50; ninthly repeat steps four through eight for the remaining undamaged shingles 45 selected in step three; tenthly identifying a random sample of two or more roofing shingles 45, which will serve as an experimental group, that contains enough shingles 45 to provide statistically significant results that allow for extrapolation to a section or the entirety of the roof 40; eleventhly repeating steps four through eight for each shingle 45 in the experimental group; twelfthly comparing the uplift force measurements of the control group with the uplift force measurements of the experimental group and determining if a statistically significant difference exists between the uplift force measurements collected during testing of each group.

While the foregoing exemplary non-limiting embodiments of the roof access system have been disclosed herein, certain modifications may be made by those skilled in the art to modify the embodiments without departing from the spirit of the invention.

What is claimed:

1. A shingle damage testing apparatus comprising:
a load distribution bar;
wherein the load distribution bar is constructed of a rigid material;
wherein the load distribution bar comprises a lifting pick point and a plurality of architectural shingle pick points;
wherein the load distribution bar provides a plurality of couplers;
wherein the plurality of couplers are pivotally attached to the architectural shingle pick points;
a radial uplift gauge;
wherein the radial uplift gauge comprises a radial section and a flat section;
wherein the flat section is attached to a clamp;
wherein the clamp is configurable to detachably attach to a free edge of an adjacent shingle;
a lifting scale;
wherein the lifting scale is portable and handheld;
wherein the lifting scale attaches to the lifting pick point.

2. The apparatus as described in claim 1, wherein the load distribution bar has a top edge and a bottom edge opposite from the top edge; and wherein the lifting pick point is adjacent to a middle portion of the top edge of the load distribution bar.

3. The apparatus as described in claim 1, wherein the load distribution bar has a top edge and a bottom edge opposite from the top edge; and wherein the plurality of architectural shingle pick points is adjacent to the bottom edge and equally spaced.

4. The apparatus as described in claim 3, wherein each of the architectural shingle pick points is aligned on a same horizontal line.

5. The apparatus as described in claim 1, wherein the radial section is configured with a graduated scale.

6. The apparatus as described in claim 1, wherein the radial section extends vertically about a predetermined radius from the flat section.

7. A shingle damage testing apparatus comprising:
a load distribution bar;
wherein the load distribution bar is constructed of a rigid material;
wherein the load distribution bar comprises a lifting pick point and a plurality of three-tab shingle pick points;
wherein the load distribution bar provides a plurality of couplers;
wherein the plurality of couplers are pivotally attached to the three-tab shingle pick points;
a radial uplift gauge;
wherein the radial uplift gauge comprises a radial section and a flat section;
wherein the flat section is attached to a clamp;
wherein the clamp is configurable to detachably attach to a free edge of an adjacent shingle;
a lifting scale;
wherein the lifting scale is portable and handheld;
wherein the lifting scale attaches to the lifting pick point.

8. The apparatus as described in claim 7, wherein the load distribution bar has a top edge and a bottom edge opposite from the top edge; and wherein the lifting pick point is adjacent to a middle portion of the top edge of the load distribution bar.

9. The apparatus as described in claim 7, wherein the load distribution bar has a top edge and a bottom edge opposite from the top edge; and wherein the plurality of three-tab shingle pick points is adjacent to the bottom edge and equally spaced.

10. The apparatus as described in claim 9, wherein each of the three-tab shingle pick points is aligned on the same horizontal line.

11. The apparatus as described in claim 7, wherein the radial section is configured with a graduated scale.

12. The apparatus as described in claim 9, wherein the radial section extends vertically about a predetermined radius from the flat section.

13. A shingle damage testing apparatus comprising:
a load distribution bar;
wherein the load distribution bar is constructed of a rigid material;
wherein the load distribution bar comprises a lifting pick point, a plurality of architectural shingle pick points, and a plurality of three-tab shingle pick points;
wherein the load distribution bar provides a plurality of couplers;
wherein the plurality of couplers are pivotally and removably attached to the architectural shingle pick points or the three-tab shingle pick points;
a radial uplift gauge;
wherein the radial uplift gauge comprises a radial section and a flat section;
wherein the flat section is attached to a clamp;
wherein the clamp is configurable to detachably attach to a free edge of an adjacent shingle;
a lifting scale;
wherein the lifting scale is portable and handheld;
wherein the lifting scale attaches to the lifting pick point.

14. The apparatus as described in claim 13, wherein the load distribution bar has a top edge and a bottom edge opposite from the top edge; and wherein the lifting pick point is adjacent to a middle portion of the top edge of the load distribution bar.

15. The apparatus as described in claim 13, wherein the load distribution bar has a top edge and a bottom edge opposite from the top edge; and wherein the plurality of architectural shingle pick points is adjacent to the bottom edge and equally spaced.

16. The apparatus as described in claim 13, wherein the load distribution bar has a top edge and a bottom edge; and wherein the plurality of three-tab shingle pick points is adjacent to the bottom edge and equally spaced.

17. The apparatus as described in claim 15, wherein each of the architectural shingle pick points is aligned on the same horizontal line.

18. The apparatus as described in claim 16, wherein each of the three-tab shingle pick points is aligned on the same horizontal line.

19. The apparatus as described in claim 13, wherein the radial section is configured with a graduated scale.

20. The apparatus as described in claim 13, wherein the radial section extends vertically about a predetermined radius from the flat section.
